(19) United States
(12) Patent Application Publication
(10) Pub. No.: US 2011/0064232 A1
(43) Pub. Date: Mar. 17, 2011

(54) METHOD AND DEVICE FOR ANALYSING AND ADJUSTING ACOUSTIC PROPERTIES OF A MOTOR VEHICLE HANDS-FREE DEVICE

(76) Inventor: Dietmar RUWISCH, Berlin (DE)

(21) Appl. No.: 12/878,674

(22) Filed: Sep. 9, 2010

(30) Foreign Application Priority Data
Sep. 11, 2009 (DE) 10 2009 029 367.1

(51) Int. Cl. H04R 29/00

(52) U.S. Cl. 381/59

(57) ABSTRACT

Method and device for analysing and adjusting acoustic properties of a hands-free device of a motor vehicle, including at least one hands-free microphone, at least one vehicle loudspeaker and a first radio interface, using a calibrated measuring microphone and a calibrated test loudspeaker and a data processing device which is connected to the measuring microphone and test loudspeaker and includes a second radio interface.

### RELATED APPLICATION

This application is based upon and claims the benefit of priority from German patent application No. 10 2009 029 367.1, filed on Sep. 11, 2009, the disclosure of which is incorporated herein in its entirety by reference.

### TECHNICAL FIELD

The present invention concerns a method and a device for analysing, and in particular adjusting, acoustic properties of a motor vehicle hands-free device. In particular, the present invention concerns a method and a device for adapting motor vehicle hands-free devices to the acoustics of the vehicle in which the hands-free device is fitted.

### BACKGROUND ART

The hands-free device for telephoning in the motor vehicle is nowadays typically one of multiple audio components in the motor vehicle, and must for example interact in the motor vehicle with the radio and/or the acoustic output of a navigation device. These multiple audio components result in complex requirements for the acoustic properties of the whole audio system in the motor vehicle, since as well as the pure sound output, a reception and transmission channel, for example, is also required during telephoning, or for acoustic operation of components of the motor vehicle. For this reception channel, a microphone, usually from an appropriately specialised supplier, is used. Although here precise specifications are given for all components of the audio system, and should ensure smooth interaction, owing to the complexity of the whole system unwanted phenomena occur which cannot be controlled using the specifications alone.

In the development phase of a motor vehicle, therefore, the complete audio system including hands-free device with built-in microphone is measured more precisely by vehicle model specific tuning, in particular of the hands-free device, being carried out in the original equipment to overcome the unwanted phenomena and adapt the vehicle hands-free device as well as possible to the acoustics of the vehicle. Until now, special measurement equipment, with which the acoustics of the vehicle is determined and, in the case of deviations from the specification, with the help of expert knowledge, individual parameters of the audio components are then changed to optimise the audio quality, has usually been required for this tuning. The repeated measurements which are required for this purpose and the evaluation thereof often prove to be difficult, since often only empirical values exist for the necessary system parameter changes to conform to the specifications, and—owing to the mutual dependencies of the system parameters and their acoustic effects—whereas changing one system parameter does result in conformity with the specifications at one point, it also results in infringement of them at another point.

The performance of the telephone hands-free device is also typically determined on the basis of a comprehensive specification and measurement rules of the Verband der Deutschen Automobilhersteller (VDA) (German automotive manufacturers' association). For this purpose, the specifications and measurement rules prescribe an acoustic measurement which is typically carried out using very expensive measuring equipment. An essential element of this measuring equipment is an artificial torso, which is placed on the driver's seat of the vehicle in such a way that a calibrated loudspeaker of the torso, as an artificial mouth, is at a defined distance from the hands-free microphone which is built into the vehicle. As well as the artificial mouth loudspeaker, the artificial torso has “artificial ears” in the form of calibrated measuring microphones, which receive what a standard person on the drivers seat of the vehicle would hear. An audio system, which is controlled by corresponding analysis software on a connected PC, is connected to this artificial torso to generate and receive test signals. Also, for communication with the vehicle hands-free device, a commercially available mobile telephone is used, which is connected to the hands-free device. However, with this mobile telephone being used for the measurement, a further factor, which is difficult to calculate, comes into the signal path, since the connection quality to the hands-free device via the mobile telephone is undetermined and fluctuates, and in addition the mobile telephone itself, for example, carries out noise suppression or echo cancelling in the signal path in addition to the hands-free device, which noise suppression or echo cancelling should be switched off for the measurement, but this is not always possible—with incalculable consequences for the measurement result.

One solution, which here at least eliminates the imponderables of the mobile communication network, is the use of a network simulator as specified by VDA, with which the public mobile communication network is bypassed and the mobile telephone is connected to a “private” mobile communication cell, to exchange signals between the mobile telephone and the vehicle hands-free device. However, such network simulators are very expensive, and special knowledge is necessary to use them properly.

Another problem is the possibility of setting the system parameters of the vehicle hands-free device. Often only proprietary interfaces and correspondingly unmanageable software tools are made available for this purpose.

There are further problems in hands-free telephoning in the interaction of the audio components, since for example care has to be taken that the radio is switched off, or the navigation system makes no announcements, during telephoning. These and other problems could be solved by means of echo cancelling, but for that more precise tuning of the interfaces of the individual audio components would be required, and in practice that is not usually guaranteed.

Most communication applications inside and outside the motor vehicle use, in order to pick up the speaker's voice, a single microphone followed by digital signal processing to improve the transmission quality. Using purely mechanical methods in the microphone housing, a certain directional characteristic of the sound reception can be implemented, which in a noisy environment such as a motor vehicle results in an improvement of the signal-to-noise ratio if the position of the speaker is known and relatively unchangeable. If, instead of one microphone, two (or more) of them are used, this is called a microphone array, and by this means it is possible to achieve sensitivity to direction in the digital signal processing. Here, first the conventional “shift and add” and “filter and add” methods should be mentioned, in which a microphone signal is shifted in time or filtered relative to the second one, before the thus manipulated signals are added. In this way, it is possible to achieve sound cancellation (“destructive interference”) for signals which come from a specified direction. Since the underlying wave geometry is formally identical to the generation of a directional effect in radio applications using multiple aerials, the term “beam forming” is also used, the “beam” of radio waves being replaced by the attenuation direction in the case of the two-microphone technique. The term “beam forming” has become accepted as a generic term for microphone array applications, although actually no “beam” is involved here. Confusingly, the term is not only used for the conventional multiple microphone technique described above, but also for more advanced, non-linear array techniques, for which the analogy with the aerial technique no longer applies at all.

However, these conventional methods miss the actually desired goal. For example, in the vehicle hands-free device, it is not very helpful to attenuate sound signals coming from a specified direction. Instead, the reverse is required: as far as possible, to pass on only signals coming from one specified direction, that is those from the direction of the speaking person.

Such a method is known from EP1595427B1. Differently from the above-mentioned directional effect, in this method, using mechanical means in the microphone housing, the angle and width of the “directional cone” (or more accurately the hyperboloid of revolution) and the attenuation for signals outside the directional cone can be controlled by preset parameters.

In practice, some disadvantages of this method are evident. The results correspond to the desired result only in the free field and near field, and a furthermore very low tolerance of the used components (including microphones) is required, since deviations in the phases of the microphone signals have a negative effect on the performance of the method. The required exacting component tolerances can usually be achieved by using suitable technologies even in mass production, but the near field/free field restrictions are more difficult to circumvent. Free field means that the sound wave arrives unhindered, that is without having been reflected, attenuated or otherwise changed on the signal path. In the near field, in contrast to the far field, in which the sound signal arrives as a plane wave, the curvature of the wave front is still evident. Even if this is actually an unwanted deviation from the assumptions of the method, in one essential point there is great similarity to the free field: since the signal source is so near, the phase disturbances owing to reflections or similar are small in comparison to the desired signal.

However, particularly in the vehicle interior, such phase effects are considerable, since several smooth surfaces near the at least two microphones in the microphone array interfere with the phase relationship between the microphone signals so strongly that the result of the signal processing according to the method described above is unsatisfactory.

Altogether, the (acoustic) integration of a hands-free device into the vehicle is often problematical owing to the diverse acoustic requirements, and in many cases the solution requires expert know-how and much experience, in particular if only limited possibilities for interacting with the whole acoustic system are made available. For the motor vehicle manufacturers, this situation is extremely unsatisfactory, since for every vehicle model they want the best possible audio performance of all components in the whole audio system, including the hands-free device, but the complicated calibration and tuning procedure required for this is too resource-intensive and expensive for many manufacturers.

### SUMMARY

It is therefore the object of the present invention to propose a method and a device for analysing and adjusting acoustic properties of a vehicle hands-free device, said method and device avoiding the disadvantages of the prior art as far as possible, and making possible, in particular with relatively simple means, an analysis of the audio properties and automatic setting of important parameters of the hands-free device, in particular to adapt the whole acoustic system, with the integrated audio components including the hands-free device, to the acoustic properties of the motor vehicle model, and to adapt the components to each other.

According to the invention, this object is achieved by a method for analysing and adjusting acoustic properties of a hands-free device of a motor vehicle, including at least one hands-free microphone, at least one vehicle loudspeaker and a first radio interface, using a calibrated measuring microphone and a calibrated test loudspeaker, and a data processing device which is connected to the measuring microphone and test loudspeaker and includes a second radio interface, comprising the steps of arranging the measuring microphone and test loudspeaker in the region of a headrest of a drivers seat in the motor vehicle, establishing a first data channel between the first and second radio interfaces by the data processing device, the first data channel being set up for transmission of audio data between the hands-free device and the data processing device, establishing a second data channel between the first and second radio interfaces by the data processing device, the second data channel being set up for transmission of control commands and measured values between the data processing device and the hands-free device, switching the hands-free device to a calibration mode by a control command sent by the data processing device, the hands-free device in calibration mode deactivating the automatic signal processing which is provided for the usual hands-free function, generating a first test audio signal by the data processing device, outputting the first test audio signal through the test loudspeaker, receiving the first test audio signal through the at least one hands-free microphone, as the first hands-free microphone signal, transmitting the first hands-free microphone signal via the first data channel to the data processing device, analysing the first hands-free microphone signal by determining its frequency response, adjusting the frequency response of the first hands-free microphone signal by determining first frequency-dependent amplification values for correcting the first hands-free microphone signal, transmitting the first frequency-dependent amplification values via the second data channel to the hands-free device, and storing the first frequency-dependent amplification values in a microphone equaliser of the hands-free device.

There is further provided a device for analysing and adjusting acoustic properties of a hands-free device of a motor vehicle with at least one hands-free microphone, at least one vehicle loudspeaker and a first radio interface, the device including a calibrated measuring microphone and a calibrated test loudspeaker, and a data processing device which is connected to the measuring microphone and test loudspeaker and has a second radio interface, and the measuring microphone and test loudspeaker being arranged in the region of a headrest of a driver's seat of the motor vehicle. The data processing device further comprises means for establishing a first data channel between the first and the second radio interface, the first data channel being set up to transmit audio data between the hands-free device and the data processing device, means for establishing a second data channel between the first and the second radio interface, the second data channel being set up to transmit control commands and measured values between the data processing device and the hands-free device, means for switching the hands-free device to a calibration mode, the hands-free device in calibration mode deactivating the automatic signal processing which is provided for the usual hands-free function, means for generating a first test audio signal, means for outputting the first test audio signal through the test loudspeaker, means for receiving the first test audio signal through the at least one hands-free microphone as the first hands-free microphone signal, means for receiving the first hands-free microphone signal via the first data channel, means for analysing the first hands-free microphone signal by determining the frequency thereof, means for adjusting the frequency response of the first hands-free microphone signal by determining first frequency-dependent amplification values for correcting the first hands-free microphone signal, and means for transmitting the first frequency-dependent amplification values via the second data channel to the hands-free device.

There is further provided a computer program product comprising physical computer readable storage medium containing computer readable executable program code for analysing and adjusting acoustic properties of a hands-free device of a motor vehicle, including at least one hands-free microphone, at least one vehicle loudspeaker and a first radio interface, using a calibrated measuring microphone and a calibrated test loudspeaker, and a data processing device which is connected to the measuring microphone and test loudspeaker and includes a second radio interface, and wherein the computer program is executable by a processor, the computer executable code comprises code portions to carry out methods consistent with the principles of the present invention.

Advantageous further developments of the invention are each defined in the dependent claims and the detailed description of the present application.

The method according to the invention does not require the expensive measuring and testing equipment consisting of artificial torso, audio system with connected system, mobile telephone and network simulator, but provides a data processing device using which at least two radio data channels to the hands-free device are established. A first data channel is set up to transmit audio data between the hands-free device and the data processing device. A second data channel is set up to transmit control commands and measured values between the data processing device and the hands-free device. By a control command which is sent from the data processing device to the hands-free device via the second data channel, the hands-free device is switched to a calibration mode, whereby the automatic signal processing which is provided for the usual hands-free function is deactivated. A first test audio signal, which is output by a calibrated test loudspeaker, is received by a hands-free microphone of the hands-free device as a first hands-free microphone signal, and transmitted via the first data channel to the data processing device. In the data processing device, the first hands-free microphone signal is then analysed by determining its frequency response. From the frequency response, frequency-dependent amplification values to correct the first hands-free microphone signal can then be determined, to adjust the frequency response of the first hands-free microphone signal to the acoustic conditions in the motor vehicle. The frequency-dependent amplification values are then transmitted via the second data channel to the hands-free device, and stored there as corresponding amplification values for correcting the hands-free microphone signal in a microphone equaliser of the hands-free device. The method and the device thus provide the possibility of testing the telephone hands-free device in the motor vehicle directly using defined test audio signals, and adjusting their frequency response by using the selected hands-free microphone signals, corresponding correction values for the amplification being written directly back into the hands-free device to correct the hands-free microphone signals. A further advantage of the invention is that for analysing and adjusting the acoustic properties of the vehicle interior, external equipment such as the network simulator is no longer required. Instead, by establishing the data channels and arranging the measuring microphone, test loudspeaker and other measuring equipment within the motor vehicle, the method can be carried out even, for example, during a test drive, for example by attaching the measuring microphone and test loudspeaker to the side of the driver's headrest, without thereby disturbing the driver. Uncomplicated and particularly accurate analysis and adjustment are thus possible.

According to a further development of the invention, a method and a device are proposed which provide adjustment of the loudspeaker branch of the hands-free device by adjusting the frequency response of the loudspeaker branch by specifying second frequency-dependent amplification values, which are written in a loudspeaker equaliser of the hands-free device to correct the loudspeaker signal.

In this way, the vehicle hands-free device, as a component in the whole audio system of a motor vehicle, can be switched to a calibration mode adjusted to and both the microphone branch and the loudspeaker branch simply and without detours via, for example, a mobile telephone and a network simulator.

The problem of calibrating the microphone array in the case of multiple hands-free microphones can be remedied, according to one aspect of the invention, by calibration in which the unwanted effects are received in a calibration procedure and then taken into account in the signal processing. To do this, an audio test signal, for example white noise, is played from the expected position of the signal source, for example near the headrest of the driver's seat, and received by the microphone array, and the reception is analysed accordingly. The analysis includes determining the frequency-dependent phase difference of the received microphone signals. This frequency-dependent phase difference of the received microphone signals is then used to determine a filter function which is dependent on the microphone signal, the spectral filter coefficients being calculated using a predetermined filter function, the argument of which is the angle of incidence of a spectral signal component. The angle of incidence is determined from the phase angle between the two microphone signal components using trigonometrical functions and their inverse functions. This calculation is also spectrally resolved, i.e. is done separately for each frequency which can be represented. The angle and width of the directional cone and the maximum attenuation are parameters of the filter function. It can be assumed that the phase effects are stable over time and always the same in one vehicle type, since in mass production the microphone is permanently installed in a predetermined location, and the phase effects owing to glass, etc. are always more or less equal. Of course, if necessary, instead of only model-specific calibration, each individual device can be calibrated. In this way, it would be possible to compensate not only for the phase effects which are typical for the model, but also for the phase effects which are caused by component tolerances.

### BRIEF DESCRIPTION OF THE DRAWINGS

FIG. 1 shows an embodiment of the device according to the invention, in interaction with a motor vehicle hands-free device.

FIG. 2 shows, in a block diagram, the more detailed configuration of the telephone hands-free device.

FIG. 3 shows, in the block diagram, the more detailed configuration of the data processing device according to a further embodiment of the invention.

### DETAILED DESCRIPTION

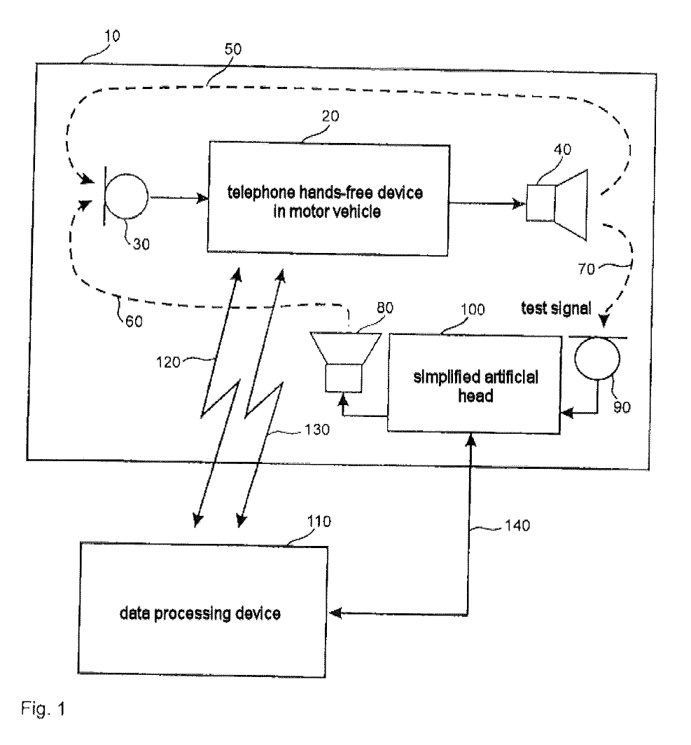

According to an embodiment of the invention, FIG. 1 shows the hands-free device 20 arranged in a vehicle interior 10, with a hands-free microphone 30 and a vehicle loudspeaker 40. Between the vehicle loudspeaker 40 and the hands-free microphone 30, an echo path 50 is formed in the vehicle interior 10. Additionally, in the vehicle interior, a so-called simplified artificial head 100 with a calibrated measuring microphone 90 and a calibrated test loudspeaker 80 are arranged closed to one seat of the car, preferably the driver's seat and more preferably in the region of a headrest of the driver's seat in the vehicle interior. The simplified artificial head 100 is connected to a data processing device 110 via a data connection 140, via which the data processing device transmits audio test signals for output via the test loudspeaker to the artificial head, and receives measuring microphone signals received by the measuring microphone. The hands-free device 20 and the data processing device 110 are also set up so that they transmit test audio signals via a wireless audio connection 120 and parameters and control commands via a wireless data connection 130.

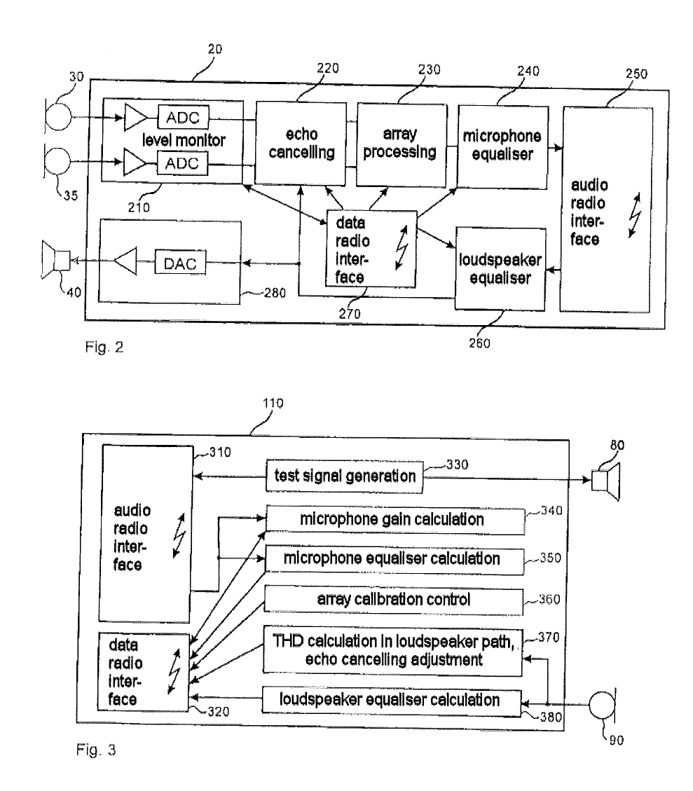

FIG. 2 shows the hands-free device 20 according to a further embodiment, with at least two hands-free microphones 30 and 35 to receive audio signals via an input module 210, which is set up to monitor the level of the received audio signals and has an analogue-digital converter (ADC) for each microphone. The received microphone signals then pass through modules 220 and 230 for echo cancelling and array processing, before their frequency response is then corrected as required in a microphone equaliser 240. The microphone signal, corrected as required, is then transmitted in calibration mode via an audio radio interface 250 and the wireless audio connection 120 to the data processing device 110. According to FIG. 3, the data processing device has an audio radio interface 310, to receive the hands-free microphone signals via the wireless audio connection 120. The hands-free microphone signals which the audio radio interface 310 receives are then further processed in the modules 340 and 350, for microphone amplification calculation and microphone equaliser calculation. In this case, frequency-dependent amplification values for correcting the hands-free microphone signals are calculated, and are then transmitted via a data radio interface 320 and the wireless data connection 130 to a data radio interface 270 of the hands-free device, and there stored in the microphone equaliser 240 as corrected amplification values.

According to the embodiment shown in FIG. 3, the data processing device 110 also has an array calibration control 360, and a module for THD calculation in the loudspeaker path and for echo cancelling adjustment 370.

When calibrating the microphone branch of the hands-free device, the data processing device first generates a control command, which is transmitted by the data radio interface 320 via the wireless data connection 130 to the data radio interface 270 of the hands-free device, and switches the hands-free device to calibration mode. The data processing device then generates, in the test signal generation module 330, a test audio signal, which is output via the test loudspeaker 80 in the vehicle interior 10 and received by the at least one hands-free microphone 30 of the hands-free device via the acoustic path 60.

For the loudspeaker branch, an audio test signal is also generated in the test signal generation module 330, and is then transmitted by the audio radio interface 310 via the wireless audio connection 120 to the audio radio interface 250 of the hands-free device, to be output there if required via the loudspeaker equaliser 260 of the output unit 280 and the vehicle loudspeaker 40. The output unit 280 has a corresponding digital-analogue converter (DAC). The audio test signal output by the vehicle loudspeaker 40 is received by the measuring microphone 90 via the acoustic path 70 as the measuring microphone signal. In the loudspeaker equaliser calculation module 380, the frequency response of the measuring microphone signal is then determined, and from the frequency response frequency-dependent amplification values for correcting the measuring microphone signal are calculated, and are then transmitted by the data radio interface 320 via the wireless data connection 130 to the data radio interface 270, and stored as corrected frequency-dependent amplification values in the loudspeaker equaliser 260, for correcting the signals in the loudspeaker branch.

The analysis and adjustment of the signals in the microphone branch of the hands-free device are described below on the basis of various embodiments.

A “tuning set” consisting of a calibrated microphone-loudspeaker combination 80, 90 as a simplified artificial head 100 is mounted on the headrest of the driver's seat and connected via the data connection 140 to a Bluetooth-capable PC as the data processing device 110. For the purposes of the further description, the tuning set includes the measuring microphone, the test loudspeaker and the data processing device, unless otherwise stated.

The PC is connected to the hands-free device 20 by Bluetooth audio connection, as a wireless audio connection 120 according to the Bluetooth hands-free profile. The PC also establishes an additional, proprietary Bluetooth connection to the hands-free device, as a wireless data connection 130 according to the Bluetooth serial port profile. The Bluetooth audio connection corresponds to the first data channel, as a synchronous data connection, and the proprietary Bluetooth connection corresponds to the second data channel, as an asynchronous data connection. According to one embodiment of the invention, the first and second data channels are combined into one data channel, via which both the audio data and the control commands and measured values are transmitted between the PC as the data processing device and the hands-free device.

The PC then puts the hands-free device into “tuning mode” by a control command transmitted via the Bluetooth data connection, whereupon the hands-free device deactivates the signal processing (equaliser, automatic gain control, noise reduction, echo cancelling, etc.) which is required for the usual hands-free function, and carries out the analysis and adjustment procedures described below. The parameters which are calculated by the PC and/or in the hands-free device are stored in resident manner in the hands-free device, for example in the microphone equaliser 240 or loudspeaker equaliser 260, to be used later in the signal processing of the microphone and/or loudspeaker signals.

The loudspeaker (“artificial mouth”) 80 of the tuning set outputs test audio signals (for example white noise), which are received by the hands-free microphone 30 of the hands-free device 20 and sent via the Bluetooth audio connection 120 to the PC of the tuning set, where the received signal is analysed. The properties of the microphone 30 and vehicle interior 10 influence the frequency response of the signal; this can be corrected by the microphone equaliser 240 in the hands-free device.

The frequency response is calculated as follows:

Mₛₒₗₗ(f) is the target energy of the microphone signal in the hands-free device at frequency f in an optimally adjusted system when the test signal is output from the loudspeaker 80 of the tuning set.

Mᵢₛₜ(f) is the actual energy of the same signal, from which an equaliser can be determined as follows:

G_{M}(f)=10 log₁₀(Mₛₒₗₗ(f)/Mᵢₛₜ(f)),

where G_{M}(f) is the amplification in dB at frequency f, which is to be applied to the microphone signal in the hands-free device to compensate for the deviation from the target. The totality of the gain factors at the realised frequencies f is called the equaliser.

According to one embodiment, the equaliser is further corrected. If the result of the calculation of G_{M}(f) is less than a lower limit Gₘᵢₙ, G_{M}(f) is set to Gₘᵢₙ, and if the result of the calculation is greater than an upper limit Gₘₐₓ, G_{M}(f) is limited to Gₘₐₓ. If such a limitation is necessary, the tuning set gives a warning, according to one embodiment, for example by outputting an appropriate warning to the PC, that an optimal frequency response adjustment of the microphone branch of the hands-free device is impossible.

According to a further embodiment, the level of the microphone signal in the hands-free device is also determined while the audio test signal is present with an attempt to avoid both overmodulation (“clipping”) and too little digital resolution of the hands-free microphone signal which would reduce the performance of the signal processing.

In this case, Pₛₒₗₗ is the target level of the hands-free microphone signal after analogue-digital conversion in the module 210, measured in dB under the maximum level of the digitised microphone signal when the test signal is output from the test loudspeaker 80 of the tuning set. Pᵢₛₜ is the actual level of the same signal in the hands-free device, and is transmitted from the data radio interface 270 of the hands-free device, via the Bluetooth data connection 130, to the PC 110. Pᵢₛₜ_{_{—}}_{EQ} is the actual level of the microphone signal, after the equaliser, which is calculated from the frequency response and stored in the microphone equaliser 240, has been applied to the microphone signal. The difference Δ=Pₛₒₗₗ−Pᵢₛₜ_{_{—}}_{EQ} is then the change of the gain factor (in dB) of the analogue amplifier in the ND converter (ADC) 210 of the microphone branch, with which it is possible to compensate for the deviation from the target level, taking account of the previously calculated equaliser. If the calculated gain change Δ cannot be achieved with the capabilities of the ND converter, the next possible achievable gain setting is chosen, and a corresponding warning is displayed on the PC, for example.

In one embodiment, in which the hands-free device has two hands-free microphones 30, 35 at a known distance, the adjustment or calibration also includes so-called array processing. In this case, a beam forming method, which is described in EP1595427B1, is modified by calibration with the audio test signals, as follows. The vertical angle θ₀, which must be preset according to EP1595427B1 and is equal for all frequencies, is replaced by frequency-dependent values θ₀(f), which are determined according to the calculation rules given in EP1595427B1 for the spatial angle θ(f), while the tuning set plays the audio test signal for the microphone branch. θ₀ must be set=0, and the values θ(f) must be averaged over time for the duration of the test signal. This calculation is done either in the hands-free device, controlled by a corresponding command of the data processing device via the Bluetooth data connection 130, or in the data processing device 110 itself, the data being transmitted to it via the Bluetooth data connection 130. The values θ₀(f) which are calculated in this way are then stored in resident manner in the hands-free device.

The values θ₀(f) are calculated as follows. In accordance with the calculation rules in EP1595427B1 for determining the spatial angle θ(f,T), this is determined for all frequencies f. The angle measurements are averaged over time for the duration of the test signal; in this way, the vector θ₀(f), which contains the result of the calibration, is determined. The filter function F(f,T), which contains the attenuation values for each frequency at instant T, is, in EP1595427B1,

Fθ₀(f,T)=Z(θ(f,T)−θ₀)+DΔ²_{f}Z(f,T)−θ₀),

and contains the settable angle which specifies the angle of the directional cone.

This adjustable parameter is omitted in the method modifications according to the invention (the diffusion term in the above equation should also be omitted for the following considerations), and instead, the vector θ₀(f), which is determined during the calibration, is used:

F(f,T)=Z(θ(f,T)−θ₀(f)),

i.e. the angle specification is replaced by the determination of a (frequency-dependent) actual angle, which contains the real phase disturbances.

The assignment function Z remains, as known from EP1595427B1, an even function on the angle θ, for example Z(θ)=((1+cos θ)/2)ⁿ, where n>0 defines the adjustable width of the directional cone. A half-value angle γ_{3db} is set with n=1/(1−log₂(cos(γ_{3db})+1)).

According to an alternative embodiment, instead of the spatial angle θ₀(f), a frequency-dependent phase angle offset φ₀(f) of the microphone signals is determined in the calibration procedure and included in the calculations. For this purpose, in all calculation instructions of EP1595427B1, the expression φ(f) is replaced by φ(f)−φ₀(f), where φ₀(f) is determined by the calibration procedure, as follows: φ₀(f) corresponds to the phase angle φ(f) (averaged over time) when the audio test signal is played for the microphone branch. In this embodiment, θ₀ is permanently set=0.

In this alternative variant, the determination of the spatial angle is therefore omitted, and instead a phase angle vector

φ₀(f)=arctan((Re1(f)*Im2(f)−Im1(f)*Re2(f))/(Re1(f)*Re2(f)+Im1(f)*Im2(f)))

is determined during the calibration procedure, where Re1(f) and Im1(f) and Re2(f) and Im2(f) designate the real and imaginary parts respectively of the spectral components of the microphones 1 and 2 (hands-free microphones 30, 35). In this variant, the phase angle vector φ₀(f) contains the calibration information, and here there is a further advantage: since the angle θ₀ no longer has to be specified for the further calculation, i.e. θ₀=0, by appropriate transformations the filter function can be applied directly to the corrected phase angles φ(f)−φ₀(f) instead of to the spatial angle θ, so that the computationally expensive spatial angle determination according to EP1595427B1, using the arc cosine function, is unnecessary.

Below, the analysis and adjustment of the signals in the loudspeaker branch of the hands-free device is described on the basis of various embodiments.

First, a test audio signal for the loudspeaker branch is generated. For this purpose, the data processing device 110 transmits an audio test signal (for example white noise) via the audio radio interface 310 and Bluetooth audio connection 120, as the first data channel, to the hands-free device, more precisely to its audio radio interface 250. The audio test signal is then output by the at least one vehicle loudspeaker 40, and received and analysed by the measuring microphone 90 (the “artificial ear”) of the tuning set. Alternatively, the signal is not transmitted via the Bluetooth audio connection, but generated in the hands-free device itself as a reaction to a data processing control command, which is sent via the Bluetooth data connection 130, as the second data channel, to the hands-free device 20.

According to one embodiment, the distortion, also called “total harmonic distortion” or THD for short, in the loudspeaker branch is determined in the loudspeaker equaliser calculation module 380 from the received test signals, to obtain information about the quality of the at least one vehicle loudspeaker 40 and of the final amplifier of the hands-free device and the audio system to which the at least one vehicle loudspeaker is connected. If THD exceeds a critical threshold (for example 5%), the echo cancelling in the hands-free device is set to “half duplex”, since “full duplex” is unachievable if the signal distortion in the loudspeaker branch is too strong. This setting is made via a corresponding control command of the tuning set via the Bluetooth data connection to the hands-free device.

The properties of the loudspeakers 40 and of the vehicle interior 10 influence the frequency response in the loudspeaker branch, and this can be corrected using an equaliser, which is then stored correspondingly in the loudspeaker equaliser 260. This equaliser must be calculated using the audio test signals in the loudspeaker branch, as follows.

Lₛₒₗₗ(f) is the target energy of the signal in the “artificial ear” of the tuning set at frequency f in an optimally adjusted system, when the audio test signal is output from the vehicle loudspeaker 40 of the hands-free device 20.

Lᵢₛₜ(f) is the actual energy of the same signal, from which an equaliser is determined according to the following formula:

G_{L}(f)=10 log₁₀(Lₛₒₗₗ(f)/Lᵢₛₜ(f)),

where G_{L}(f), the amplification in dB at frequency f, is to be applied to the loudspeaker signal in the hands-free device, to compensate for the deviation of the actual energy from the target energy.

According to one embodiment, the equaliser correction is done only relatively, in the event that the volume of the loudspeaker output in the motor vehicle still depends on another user setting, which cannot be controlled. The mean value of all G_{L}(f) is then subtracted from the calculated G_{L}(f) values. If the result of the calculation of G_{L}(f) thus obtained is less than a lower limit Gₘᵢₙ, G_{L}(f) is set to Gₘᵢₙ. In the event that the calculation result exceeds an upper limit Gₘₐₓ, G_{L}(f) is limited to Gₘₐₓ. If a limitation is necessary, according to one embodiment the tuning set gives a warning, for example by displaying an appropriate warning on the PC as the data processing device 110, that an optimal frequency response adjustment of the loudspeaker branch of the hands-free device is impossible.

According to one embodiment, the hands-free device has signal processing in the loudspeaker branch, so that the equaliser is used by transmitting the corresponding equaliser data from the data processing device 110 via the Bluetooth data connection 130 into the loudspeaker equaliser 260 of the hands-free device, storing them there, and then applying them to the loudspeaker signals. If, according an alternative embodiment, no signal processing takes place in the loudspeaker branch, the measurement is used only to document the frequency response of the loudspeaker branch of the hands-free device.

After the microphone and/or loudspeaker branch is adjusted, according to one embodiment the data processing device sends a control command via the Bluetooth data connection to the hands-free device, whereupon the hands-free device activates the previously deactivated signal processing in the hands-free device, and thus puts it back into normal hands-free operation.

According to one embodiment, the method steps for analysing and adjusting the acoustic properties in the microphone and/or loudspeaker branch are repeated with activated signal processing using the calculated parameters (equalisers and frequency-dependent amplification values), to verify and document the optimised functioning of the hands-free device.

According to a further embodiment, the calculated parameters are exported in a suitable data format, so that they are then available for mass production of the hands-free device (end-of-line programming).

The method according to the invention and the device according to the invention, and in particular the data processing device, are usefully implemented using, or in the form of, a DSP system, or as a software component of a computer program, which for example runs on a PC or DSP system or any other hardware platform.

### LIST OF REFERENCE NUMERALS

10 vehicle interior;
20 hands-free device;
30, 35 hands-free microphone;
40 motor vehicle loudspeaker;
50 echo path formed in the motor vehicle interior;
60, 70 acoustic path, also in the vehicle interior;
80 calibrated test loudspeaker;
90 calibrated measuring microphone;
100 simplified artificial head;
110 data processing device;
120 wireless audio connection;
130 wireless data connection;
140 data connection;
210 input module with ADC;
220 echo cancelling module;
230 array processing module;
240 microphone equaliser;
250 audio radio interface of hands-free device;
260 loudspeaker equaliser;
270 data radio interface of hands-free device;
280 output unit with DAC;
310 audio radio interface of data processing device;
320 data radio interface of data processing device;
330 test signal generation module;
340 microphone amplification calculation module;
350 microphone equaliser calculation module;
360 array calibration control module;
370 THD calculation/echo cancelling adjustment module;
380 loudspeaker equaliser calculation module;
f frequency;
T instant of determination of a spectrum or output signal;
Mᵢₛₜ(f) frequency-dependent actual signal energy of the first hands-free microphone signal;
Mₛₒₗₗ(f) frequency-dependent target signal energy of the first hands-free microphone signal;
G_{M}(f) frequency-dependent amplification for the first hands-free microphone signal;
G_{Mmin} minimum amplification of the hands-free microphone signal;
G_{Mmax} maximum amplification of the hands-free microphone signal;
Pᵢₛₜ actual level of the amplified first hands-free microphone signal in dB under the maximum level;
Pₛₒₗₗ target level of the first hands-free microphone signal after analogue-digital conversion in dB under the maximum level when the first test audio signal is output;
φ₀(f) frequency-dependent phase angle in calibration mode, averaged over time;
φ(f,T) frequency-dependent phase angle of the microphone signals during operation;
Re1(f), Im1(f) real and imaginary parts of the spectral components of the first hands-free microphone signal (microphone 1);
Re2(f), Im2(f) real and imaginary parts of the spectral components of the second hands-free microphone signal (microphone 2);
θ₀(f) frequency-dependent angle of incidence of the first test audio signal in calibration mode, averaged over time;
θ(f,T) frequency-dependent angle of incidence of the microphone signals during operation;
F(f,T) filter function;
Z even assignment function;
Lᵢₛₜ(f) frequency-dependent actual signal energy of the measuring microphone signal;
Lₛₒₗₗ(f) frequency-dependent target signal energy of the measuring microphone signal;
G_{L}(f) frequency-dependent amplification for the measuring microphone signal;
G_{Lnorm}(f) normalised frequency-dependent amplification;
G_{Lmin} minimum amplification of the measuring microphone signal;
G_{Lmax} maximum amplification of the measuring microphone signal.

1. A method for analysing and adjusting acoustic properties of a hands-free device of a motor vehicle, including at least one hands-free microphone, at least one vehicle loudspeaker and a first radio interface, using a calibrated measuring microphone and a calibrated test loudspeaker, and a data processing device which is connected to the measuring microphone and test loudspeaker and includes a second radio interface, comprising the following steps:
arranging the measuring microphone and test loudspeaker in the region of a headrest of a driver's seat in the motor vehicle;
establishing a first data channel between the first and second radio interfaces by the data processing device, the first data channel being set up for transmission of audio data between the hands-free device and the data processing device;
establishing a second data channel between the first and second radio interfaces by the data processing device, the second data channel being set up for transmission of control commands and measured values between the data processing device and the hands-free device;
switching the hands-free device to a calibration mode by a control command sent by the data processing device, the hands-free device in calibration mode deactivating the automatic signal processing which is provided for the usual hands-free function;
generating a first test audio signal by the data processing device;
outputting the first test audio signal through the test loudspeaker;
receiving the first test audio signal through the at least one hands-free microphone, as the first hands-free microphone signal;
transmitting the first hands-free microphone signal via the first data channel to the data processing device;
analysing the first hands-free microphone signal by determining its frequency response;
adjusting the frequency response of the first hands-free microphone signal by determining first frequency-dependent amplification values for correcting the first hands-free microphone signal;
transmitting the first frequency-dependent amplification values via the second data channel to the hands-free device; and
storing the first frequency-dependent amplification values in a microphone equaliser of the hands-free device.

2. The method according to claim 1, further comprising:
determining the frequency-dependent signal energy of the first hands-free microphone signal Mᵢₛₜ(f);
providing a frequency-dependent target signal energy Mₛₒₗₗ(f) for the first hands-free microphone signal;
calculating a frequency-dependent amplification G_{M}(f) for the first hands-free microphone signal, according to the formula:
G_{M}(f)=10 log₁₀(Mₛₒₗₗ(f)/Mᵢₛₜ(f)); and
using the frequency-dependent amplification G_{M}(f) as first frequency-dependent amplification values.

3. The method according to claim 2, further comprising:
setting the frequency-dependent amplification G_{M}(f) to G_{Mmin} if the frequency-dependent amplification G_{M}(f) is less than G_{Mmin}; and/or
setting the frequency-dependent amplification G_{M}(f) to G_{Mmax} if the frequency-dependent amplification G_{M}(f) is greater than G_{Mmax}.

4. The method according to claim 1, further comprising:
correcting the frequency response of the first hands-free microphone signal with the first frequency-dependent amplification values;
calculating an actual level Pᵢₛₜ of the amplified first hands-free microphone signal;
calculating a target level Pₛₒₗₗ of the first hands-free microphone signal;
calculating the difference between actual level and target level; and
calculating at least one second frequency-independent amplification value, to compensate for the difference between actual level and target level.

5. The method according to claim 1, wherein the hands-free device includes at least two hands-free microphones at a fixed distance from each other, and the method further comprises:
receiving the first test audio signal with the at least two hands-free microphones, as assigned hands-free microphone signals;
transmitting the assigned hands-free microphone signals via the first data channel to the data processing device;
determining a frequency-dependent phase difference between the assigned hands-free microphone signals;
determining a frequency-dependent angle of incidence θ₀(f), averaged over time, of the first test audio signal, on the basis of the frequency-dependent phase difference;
determining an output signal by multiplying one of the two assigned hands-free microphone signals to a filter function F(f,T) on the basis of the angle of incidence θ₀(f), the filter function being:
F(f,T)=Z(θ(f,T)−θ₀(f)),
where
f is the respective frequency
T is the instant at which the output signal is determined
Z is an even assignment function
θ₀(f) is the frequency-dependent angle of incidence in calibration mode, averaged over time, and
θ(f,T) is the frequency-dependent angle of incidence of the microphone signals during operation.

6. The method according claim 1, wherein the hands-free device includes at least two hands-free microphones at a fixed distance from each other, and the method further comprises:
receiving the first test audio signal with the at least two hands-free microphones as assigned hands-free microphone signals;
transmitting the assigned hands-free microphone signals via the first data channel to the data processing device;
determining a frequency-dependent phase difference between the assigned hands-free microphone signals, a phase angle vector
φ₀(f)=arctan((Re1(f)*Im2(f)−Im1(f)*Re2(f))/(Re1(f)*Re2(f)+Im1(f)*Im2(f)))
being determined, and
Re1(f) and Im1(f) and Re2(f) and Im2(f) designating the real and imaginary parts respectively of the spectral components of the two hands-free microphones;
determining an output signal by multiplying one of the two assigned hands-free microphone signals to a filter function F(f,T) based on the phase angle vector φ₀(f), the filter function being:
F(f,T)=Z(φ(f,T)−φ₀(f)),
where:
φ₀(f) is the frequency-dependent phase angle in calibration mode, averaged over time, and
φ(f,T) is the frequency-dependent phase angle of the microphone signals during operation.

7. The method according to claim 1, further comprising:
generating a second test audio signal;
outputting the second test audio signal through the at least one vehicle loudspeaker;
receiving the second test audio signal through the measuring microphone, as a measuring microphone signal;
determining the frequency response of the at least one vehicle loudspeaker by analysing the measuring microphone signal;
adjusting the frequency response of the vehicle loudspeaker by determining second frequency-dependent amplification values to correct the measuring microphone signal;
transmitting the second frequency-dependent amplification values via the second data channel to the hands-free device; and
storing the second frequency-dependent amplification values in a loudspeaker equaliser of the hands-free device.

8. The method according to claim 7, further comprising:
determining the frequency-dependent signal energy of the measuring microphone signal Lᵢₛₜ(f);
providing a frequency-dependent target signal energy Lₛₒₗₗ(f) for the measuring microphone signal;
calculating a frequency-dependent amplification G_{L}(f) for the measuring microphone signal, according to the formula:
G_{L}(f)=10 log₁₀(Lₛₒₗₗ(f)/Lᵢₛₜ(f)), and
using the frequency-dependent amplification G_{L}(f) as second frequency-dependent amplification values.

9. The method according to claim 8, further comprising:
subtracting the mean value of all G_{L}(f) from the individual G_{L}(f) values, and generating a normalised frequency-dependent amplification G_{Lnorm}(f);
setting the frequency-dependent amplification G_{Lnorm}(f) to G_{Lmin} if the frequency-dependent amplification G_{Lnorm}(f) is less than G_{Lmin}; and/or
setting the frequency-dependent amplification G_{Lnorm}(f) to G_{Lmax} if the frequency-dependent amplification G_{Lnorm}(f) is greater than G_{Lmax}.

10. The method according to claim 1, further comprising:
switching the hands-free device to a normal operating mode by a control command sent by the data processing device via the second data channel, the hands-free device activating the automatic signal processing which is provided for the usual hands-free function.

11. The method according to claim 10, further comprising:
repeating the adjustment of the hands-free device, the automatic signal processing which is provided for the usual hands-free function remaining activated.

12. The method according to claim 1, further comprising:
exporting at least one of the calculated signal processing parameters of the hands-free device via the second data channel into the data processing device; and
storing the at least one exported signal processing parameter in a preferably non-volatile memory of the data processing device; and
exporting at least one of the calculated signal processing parameters of the hands-free device into a firmware image, which provides the signal processing parameters for programming the hands-free device during mass production.

13. The method according to claim 1, further comprising establishing a radio connection according to the Bluetooth standard between the data processing device and the hands-free device, the first data channel being provided by a synchronous Bluetooth channel and the second data channel being provided by an asynchronous Bluetooth channel.

14. A device for analysing and adjusting acoustic properties of a hands-free device of a motor vehicle with at least one hands-free microphone, at least one vehicle loudspeaker and a first radio interface, the device including a calibrated measuring microphone and a calibrated test loudspeaker, and a data processing device which is connected to the measuring microphone and test loudspeaker and has a second radio interface, and the measuring microphone and test loudspeaker being arranged in the region of a headrest of a drivers seat of the motor vehicle, and the data processing device further comprising:
means for establishing a first data channel between the first and the second radio interface, the first data channel being set up to transmit audio data between the hands-free device and the data processing device;
means for establishing a second data channel between the first and the second radio interface, the second data channel being set up to transmit control commands and measured values between the data processing device and the hands-free device;
means for switching the hands-free device to a calibration mode, the hands-free device in calibration mode deactivating the automatic signal processing which is provided for the usual hands-free function;
means for generating a first test audio signal;
means for outputting the first test audio signal through the test loudspeaker;
means for receiving the first test audio signal through the at least one hands-free microphone as the first hands-free microphone signal;
means for receiving the first hands-free microphone signal via the first data channel;
means for analysing the first hands-free microphone signal by determining the frequency thereof;
means for adjusting the frequency response of the first hands-free microphone signal by determining first frequency-dependent amplification values for correcting the first hands-free microphone signal; and
means for transmitting the first frequency-dependent amplification values via the second data channel to the hands-free device.

15. The device according to claim 14, which is further set up to carry out the method according to any one of claim 1.

16. A computer program product comprising physical computer readable storage medium containing computer readable executable program code for analysing and adjusting acoustic properties of a hands-free device of a motor vehicle, including at least one hands-free microphone, at least one vehicle loudspeaker and a first radio interface, using a calibrated measuring microphone and a calibrated test loudspeaker, and a data processing device which is connected to the measuring microphone and test loudspeaker and includes a second radio interface, and wherein the computer program is executable by a processor, the computer executable code comprising:
a code portion for arranging the measuring microphone and test loudspeaker in the region of a headrest of a drivers seat in the motor vehicle;
establishing a first data channel between the first and second radio interfaces by the data processing device, the first data channel being set up for transmission of audio data between the hands-free device and the data processing device;
a code portion for establishing a second data channel between the first and second radio interfaces by the data processing device, the second data channel being set up for transmission of control commands and measured values between the data processing device and the hands-free device;
a code portion for switching the hands-free device to a calibration mode by a control command sent by the data processing device, the hands-free device in calibration mode deactivating the automatic signal processing which is provided for the usual hands-free function;
a code portion for generating a first test audio signal by the data processing device;
a code portion for outputting the first test audio signal through the test loudspeaker;
a code portion for receiving the first test audio signal through the at least one hands-free microphone, as the first hands-free microphone signal;
a code portion for transmitting the first hands-free microphone signal via the first data channel to the data processing device;
a code portion for analysing the first hands-free microphone signal by determining its frequency response;
a code portion for adjusting the frequency response of the first hands-free microphone signal by determining first frequency-dependent amplification values for correcting the first hands-free microphone signal;
a code portion for transmitting the first frequency-dependent amplification values via the second data channel to the hands-free device; and
a code portion for storing the first frequency-dependent amplification values in a microphone equaliser of the hands-free device.
